(19) United States
(12) Patent Application Publication
(10) Pub. No.: US 2022/0238003 A1
(43) Pub. Date: Jul. 28, 2022

(54) INSULATION PANEL AND SYSTEM

(71) Applicant: BASF SE, Ludwigshafen am Rhein (DE)

(72) Inventors: Thomas KICIAK, Ludwigshafen am Rhein (DE); Juergen VON AUENMUELLER, Ludwigshafen am Rhein (DE); Marco NAU, Ludwigshafen am Rhein (DE); Eva-Maria MUELLER, Ludwigshafen am Rhein (DE); Klaus RIES, Ludwigshafen am Rhein (DE); Fabian SCHNEIDER, Ludwigshafen am Rhein (DE)

(21) Appl. No.: 17/609,552

(22) PCT Filed: May 7, 2020
(86) PCT No.: PCT/EP2020/062741

§ 371 Date: Nov. 8, 2021

(30) Foreign Application Priority Data
May 9, 2019 (EP) 19173519.0

(51) Int. Cl. G08B 21/20; E04B 1/80; G01D 7/00; G01D 11/30; G08B 21/18

(52) U.S. Cl. CPC G08B 21/20; E04B 1/80; G08B 21/182; G01D 11/305; G01D 7/00

(57) ABSTRACT

Insulation panel comprising: at least one sensor unit comprising at least one moisture senor configured to provide moisture data; at least one communication interface configured to establish a communication with a read-out device and to transmit the moisture data to the read-out device; at least one memory unit configured to store identification data of the insulation panel.

### FIELD OF THE INVENTION

The present invention relates to an insulation panel, a notification system comprising at least one such insulation panel and a use of data provided by at least one such insulation panel.

### BACKGROUND OF THE INVENTION

The use of insulation boards, panels and so on and the use of different insulating materials for sealing floors, roofs and walls is well known in the prior art. For example, documents EP 2 434 478 A1 or EP 2 748 238 B1 disclose compositions and methods for the production and use of such insulation panels.

In this respect, it has turned out to be problematic that after the installation of such insulation panels, it is not easy to determine whether unwanted moisture is present or has penetrated the covered floors, walls or roofs. In practice, such surfaces are examined at regular intervals by experts who determine whether certain insulation panels or surface sections need to be repaired or even renewed. However, during these inspections, it can often only be determined that water has already penetrated certain sections of the surface and that appropriate renovation measures of the penetrated sections are necessary.

During the planning with which insulation panels or insulating materials a certain surface is to be provided, the experts rely on their empirical values, whereby also computer-assisted computation procedures are used by the expert, for example for the determination of thermal insulation values.

It is found that a further need exists to simplify the monitoring of such surfaces and to make in particular a monitoring possible, which can be accomplished also by a not expert. In addition, there is a need to improve the planning of which insulation panels and insulation materials are suitable for which surfaces, in particular to reduce the probability of failure after installation of the insulation panels.

### SUMMARY OF THE INVENTION

In the view of the above, it is an object of the present invention to provide an insulation panel and a notification system comprising at least one such insulation panel supporting maintenance services and the reliability of sealed surfaces by means of at least one such insulation panel. These and other objects, which become apparent upon reading the following description, are solved by the subject-matter of the independent claims. The dependent claims refer to preferred embodiments of the invention.

According to the invention, an insulation panel is provided, comprising: at least one sensor unit comprising at least one moisture senor configured to provide moisture data; at least one communication interface configured to establish a communication with a read-out device and to transmit the moisture data to the read-out device; at least one memory unit configured to store identification data of the insulation panel. In this respect, it is preferred that the sensor unit, the memory unit and the communication interface are provided as an integrated part, preferably as a label, which is applied onto the insulation panel by means of an adhesive layer.

An insulation panel according to the present invention is defined as any insulation material used in a form suitable for covering floors, walls or roofs. Insulation panels usually comprise at least one insulation layer and several layers providing different functions, like vapor barriers, moisture barriers and so on. In practice, above or below an insulation panel further layers of waterproofed material can be used. Typically, insulation panels have a rectangular shape, wherein any other shape can be used within the scope of the present invention. The insulation panels may have also tongue and groove elements facilitating the installation of the insulation panels. If required, separate sealings or sealing materials can be applied between the insulation panels, i.e. in particular at the joints of the insulation panels.

A moisture sensor according to the present invention can be provided by any means suitable for measuring water or moisture content. Notably, it is preferred that the insulation panel does not comprise any separate energy source for the senor unit, the communication interface and/or the memory unit for a stand-alone operation. In this respect, it is preferred that the required energy for measuring and communication is provided by a read-out device, for example, by means of an inductive coupling or the like as used in an RFID-device (radio-frequency identification device). However, depending on the specific installation conditions, it is also possible to add an energy source to the insulation panel, e.g. by an inductive rechargeable battery or by providing prefabricated conductors in the insulation panels which can be connected to an energy source at a centralized feed-in point. The advantage of equipping the insulation panel with or connecting it to a power source is that in this case a measurement can be provided at regular intervals which can be transmitted to a nearby receiver or read-out device without the need for any user intervention. On the other hand, the advantage of not equipping an insulation panel with an own energy source or connecting it to one is that it keeps the structure of the insulating panel simple and there is no risk of malfunctioning in connection with the energy supply. In this case, energy is only transferred when the data is transmitted or shortly before data is transmitted.

The communication interface is preferably provided by means of a RFID-transmitter. However, it is also possible to use other communication interfaces, for example, a Bluetooth Low Energy (BLE) interface, an Ultra Low Power Bluetooth (ULP) interface and/or a Near Field Communication (NFC) interface.

Moreover, the sensor unit, the communication interface and the memory unit can be placed at different locations on or in the insulation panel, e.g. in different cavities in the insulation panel. However, it is preferred that the sensor unit, the communication interface and the memory unit are provided as an integrated part, for example, as a label which is adhered onto a suitable surface of the insulation panel, wherein at least the sensor unit has to be placed at a location suitable for measuring the moisture content or other data, e.g. temperature, pressure, radon exposure.

A memory unit is any unit capable of storing at least one identification data of an insulation panel so that this identification data can later be read-out and transmitted together with the moisture data or further sensor data. For example, such an identification data may be a serial number of the insulation panel or the sensor unit. When the insulation panel is laid, it is recorded and stored, preferably in a database, where the insulation panel was laid. Alternatively or additionally, position data can be generated in the read-out device, for example by means of a GPS unit provided in the read-out device, wherein the position data is transmitted from the read-out device to a computer unit when the sensor data is transmitted. For example, after a roof, a floor or a wall has been covered with respective insulation panels, the impermeability and the current moisture content is checked for the first time using a read-out device having a GPS-unit. While doing so, the moisture data, the identification data and the GPS-data are transmitted to a computer unit in which the position data of the insulation panels and the identification data can be stored. Alternatively or additionally, cloud solutions can also be used for transmitting or storing the data.

In other words, by means of the present invention, it can clearly be determined where a specific insulation panel is used and in later read-out processes, the moisture data and other sensor data can thus be assigned to a defined insulation panel. Moreover, it is possible to processes the data centrally. As a result, it is even possible that a non-expert uses a read-out device transmitting the moisture data and the identification data of the insulation panel to a computing unit, e.g. a centralized computer unit or a cloud computing unit, comprising an analysis unit, e.g. an analysis software. The analyzing software in turn analysis the provided data and provide respective notification massages, e.g. recommended actions, information about the current situation and so on. In other words, after analyzing the data a notification massage about the read-out data can be provided to the user, preferably even more or less in real-time. This data can be presented on dashboards, tablet, smartphones or the like.

It is preferred that the sensor unit further comprises at least one temperature sensor configured to provide temperature data, at least one pressure sensor configured to provide pressure data and/or an acoustic sensor configured to provide acoustic data. This makes it possible to record the load acting on the insulation panels and to determine which insulation panels are subject to a particularly high load, so that it can be determined at an early stage which panels are highly likely to need to be replaced earlier or which panels require more maintenance. In addition, in particular these data can be used to better plan future projects and to take into account the fact that a higher load will occur at certain points. Moreover, in particular by means of an acoustic sensor, it is possible to measure the sound insulation provided by the insulation panels.

In particular, in case the insulation panels are used as flooring for sealing cellars, it is of advantage that the sensor unit of the insulation panel is also provided with a radon sensor configured to provide radon exposure data. In case, the flooring is not gas-tight, radioactive radon can penetrate through the soil into the cellars of houses as odorless gas and thus into living rooms or working areas.

Preferably, the memory unit is further configured to store data referring to the material of the insulation panel. In this respect, it is further preferred that the insulation material of the insulation panel is Styrodur, Neopor, Styropor, mineral wool, rock wool, silica aerogel, polyurethane aerogel, polyurethane foam, organic materials, like cellulose or straw, or a mixture thereof. The information about the material of the insulation panel and/or the measured radon exposure can be used when insulation panels are removed providing information about a required waste treatment by means of a waste disposal massage.

A notification system according to the present invention comprises: at least one insulation panel as described above; at least one read-out device configured to establish a communication with the communication interface of the insulation panel and receive at least the moisture data and the identification data of the insulation panel; at least one analysis unit to which at least the moisture data and the identification data of the insulation panel is transmitted, preferably by the at least one read-out device, and wherein the at least one analysis unit is configured to provide notification massages based on the moisture data and the identification data of the insulation panel.

A read-out device can be provided by any device suitable to establish a communication with a communication interface of an insulation panel. Depending whether or not an insulation panel has its own energy source or is connected to such an energy source, the read-out device can be used to provide wireless energy transmission, for example by an inductive energy coupling or the like. Alternatively or additionally, it is also possible to use a separate power supply device and assign only the read-out function to the read-out device. The read-out device can be a handheld device or an on-site device positioned within a transmission range of the communication interface of at least one insulation panel such that a communication between the read-out device and the communication interface of the at least one insulation panel can be established and data can be transmitted. For example, one read-out device or several read-out devices can be positioned near the insulation panels such that, if required, energy can be provided to the insulation panels and respective read-outs can be performed at predetermined times.

Subsequently, the measured data can be transmitted to a cloud solution or a central computing unit for analyzing the transmitted data by the analysis unit. Preferably, the read-out device comprises a position determining unit, preferably a Global Positioning System (GPS), configured to assign to the measured data and identification data of the insulation panel positioning information data. It is further preferred that the at least one read-out device is further configured to receive not only the moisture data and the identification data, but also temperature data, pressure data and/or radon exposure data, wherein this data is also transmitted to the at least one analysis unit, preferably by the at least one read-out device, wherein the analysis unit is further configured to provide notification massages further based on the temperature data, pressure data and/or radon exposure data. In this respect, it is further preferred that the insulation panel and/or the on-site read-out device are configured to send and receive moisture data and identification data of the insulation panels in predetermined time intervals, wherein the insulation panel and the on-site device are preferably configured to further to send and receive temperature data, pressure data and/or radon exposure data.

Preferably, the analysis unit, e.g. implemented in a central computing device or provided by means of cloud computing, is configured to execute an analysis algorithm based on the results of a machine-learning algorithm. The machine-learning algorithm preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that higher by many orders of magnitude.

It is preferred that the input data to the analysis algorithm is at least one of the following data: the moisture data, the temperature data, the pressure data and the radon data provided by the respective sensors of the insulation panels. In this respect, it is also preferred that the machine-learning algorithm is trained based on these input data.

Preferably, the at least one analysis unit provides at least one of the following notification massages:
situation massage notifying an user about the read-out data assigned to at least one specific insulation panel;
inspection massage notifying an user that at least one specific insulation panel has to be inspected;
alarm massage notifying an user that at least one specific insulation panel has urgently to be replaced;
alarm massage notifying an user that at least one specific insulation panel has a temperature above a predetermined value;
waste disposal massage notifying an user which waste treatment at least one specific insulation panel requires.

A situation massage may contain information about present situation, i.e. about the read-out data, which can be presented on any suitable output device, e.g. dashboards, tablet, smartphones or the like. In this respect, the measured values can be assigned to each specific insulation panel and presented as a graphic or as numerical values. An inspection massage may contain information about areas where increased values have been measured, e.g. values which are still within a tolerance range, but which are higher with respect to other areas of the area covered by the insulation panels. An alarm massage may contain information that a breach has been detected and that it is highly likely that water may penetrating the covered area requiring an immediate attention for avoiding lager damages. An alarm massage with respect to the measured temperature may contain information that it is highly likely that a fire has been detected. Moreover, at least the alarm massages may simultaneously and directly be provided to third parties, e.g. emergency services, responsible fire departments, etc., which may issue and handle urgent actions.

The present invention also relates to the use of the moisture data, identification data, temperature data, pressure data and/or radon exposure data obtained from an insulation panel and a system as described above for determining at least one of the following notification massages:
situation massage notifying an user about the read-out data assigned to at least one specific insulation panel;
inspection massage notifying an user that at least one specific insulation panel has to be inspected;
alarm massage notifying an user that at least one specific insulation panel has urgently to be replaced;
alarm massage notifying an user that at least one specific insulation panel has a temperature above a predetermined value;
waste disposal massage notifying an user which waste treatment at least one specific insulation panel requires.

### BRIEF DESCRIPTION OF THE DRAWINGS

In the following, the invention is described exemplarily with reference to the enclosed figure, in which

FIG. 1 is a schematic view of a notification system according to the preferred embodiment of the present invention using insulation panels according to the preferred embodiment of the present invention.

### DETAILED DESCRIPTION OF EMBODIMENTS

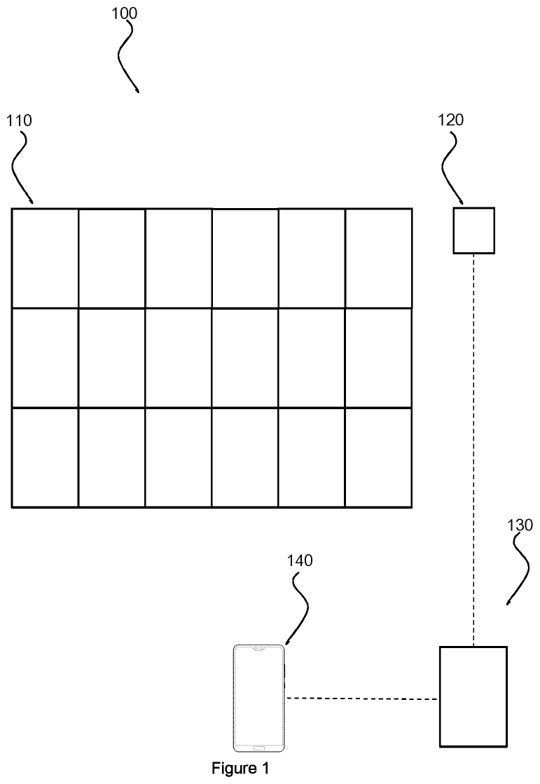

FIG. 1 is a schematic view of a notification system 100 according to the preferred embodiment of the present invention. The preferred notification system 100 comprises a plurality of insulation panels 110, at least one read-out device 120 and at least one computing device 130 and at least one output device 140.

The insulation panels 110 according to the preferred embodiment of the invention comprise a sensor unit, a communication interface and a memory unit. In the memory unit, identification data suitable to identify each one of the insulation panels 110, e.g. by means of a serial number, is stored. The sensor unit comprises a moisture sensor, a temperature sensor, a pressure sensor and a radon sensor for providing respective data. Notably, the flooring can be provided only by means of insulation panels according to the preferred embodiment of the present invention, i.e. comprising a sensor unit with one or more sensors, a communication interface and a memory unit. However, depending on the respective application, it is possible that only one or several such insulation panels are used and that the remaining area is covered with common insulation panels, i.e. without a sensor unit, a communication interface or a memory unit.

It is preferred that the insulation panels 110 do not comprise an own energy source for the senor unit, the communication interface or the memory unit for a stand-alone operation. In this respect, it is preferred that the required energy for measuring and communication is provided by the read-out device 120, for example, by means of an inductive coupling or the like as used in an RFID-device (radio-frequency identification device). However, depending on the specific installation conditions, it is also possible to add an energy source to one or more of the insulation panels 110, e.g. by an inductive rechargeable battery or by providing prefabricated conductors in the insulation panels 110 which can be connected to an energy source, e.g. at a centralized feed-in point.

The read-out device 120 in the shown preferred embodiment is an on-site device positioned within a transmission range of the communication interfaces of the insulation panels 110 such that a communication between the read-out device 120 and the communication interfaces of the insulation panels 110 can be established and data and energy can be transmitted. In an alternative embodiment, the read-out device 120 is a handheld device with which a user can walk over the insulation panels 120. It is preferred that the read-out device 120 comprises a GPS-unit such that respective positioning data can be assigned to the data of the sensor units.

In the preferred embodiment, the read-out device 120 is configured to transfer the sensor data, the identification data and the assigned positioning data to a computing device 130, e.g. a central computing device or a cloud computing device, comprising an analysis unit. However, it is also possible that the sensor data, the identification data and the assigned positioning data is transmitted to a cloud memory bevor an analysis of the data by the analysis unit is performed. By means of the analysis unit of the computing device 130, the provided data is analyzed and a respective notification massage is prepared and transmitted to the output device 140. In this respect, it is preferred that the analysis unit is configured to execute an analysis algorithm based on the results of a machine-learning algorithm, wherein it is preferred that the input data to the analysis algorithm is at least one of the following data: the moisture data, the temperature data, the pressure data and the radon data provided by the respective sensors of the insulation panels. In this respect, it is preferred that the machine-learning algorithm is also trained based on these input data. The output device 140 can be provided by any device comprising a display, e.g. a computer, laptop, smartphone, etc. Notably, the notification massages can be provided to a user and also to a data storage of a service provider for further analysis.

In the following, a method providing respective notification massages by the above explained notification system is explained:

In a first step, the insulation panels 110 are installed, e.g. on a floor, wall or roof, wherein additional layers or sealing may be applied below or above the insulation panels 110. The identification data of the insulation panels 110, e.g. a serial number of the insulation panel or of the used sensor unit, and the position of the insulation panel 110 is recorded and stored in a database. As a result, each laid insulation panel 110, identified by means of the stored identification data, it is known where it has been laid.

In a next step, a handheld read-out device is used to energize the sensor unit and the communication interface of the insulation panels 110 by placing the handheld read-out device near the respective insulation panels 110, e.g. by walking over the insulation panels 110 holding the handheld read-out device. After energizing the sensor unit and the communication interface of the insulation panels 110, the sensor data and the identification data is transmitted to the handheld read-out device. Moreover, it is preferred that also GPS-data provided the handheld read-out device is recorded and assigned to the measured data.

Subsequently, the data transmitted by the insulation panels 110 is in turn transmitted, preferably by the read-out device, to a computing device comprising an analyzing unit, wherein the data can be transmitted to the analyzing unit directly or via a cloud memory and wherein the computing device can be provided by a central computer or by a cloud computing solution.

The analyzing unit is configured to execute an analysis algorithm, preferably based on the results of a machine-learning algorithm.

Finally, the analysis unit outputs at least one of the following notification massages onto one or more output devices 140:
situation massage notifying an user about the read-out data assigned to at least one specific insulation panel;
inspection massage notifying an user that at least one specific insulation panel has to be inspected;
alarm massage notifying an user that at least one specific insulation panel has urgently to be replaced;
alarm massage notifying an user that at least one specific insulation panel has a temperature above a predetermined value;
waste disposal massage notifying an user which waste treatment at least one specific insulation panel requires.

A situation massage may contain information about present situation, i.e. about the read-out data, which can be presented on any suitable output device, e.g. dashboards, tablet, smartphones or the like. In this respect, the measured values can be assigned to each specific insulation panel and presented as a graphic or as numerical values.

An inspection massage may contain information about areas where increased values have been measured, e.g. values which are still within a tolerance range, but which are higher with respect to other areas of the area covered by the insulation panels.

An alarm massage may contain information that a breach has been detected and that it is highly likely that water may penetrating the covered area requiring an immediate attention for avoiding lager damages. An alarm massage with respect to the measured temperature may contain information that it is highly likely that a fire has been detected. Notably, such alarm massages may be provided directly to third parties such that urgent actions can be issued.

Notably, the above notification massages may be provided to a user or also to third parties, in particular, in case immediate actions are required. Moreover, in particular, the situation massages can be used to evaluate the long term specifics of the used insulation panels in order to provide data for planning future projects and to improve the life time of such insulation panels.

The present invention has been described in conjunction with a preferred embodiment as examples as well. However, other variations can be understood and effected by those persons skilled in the art and practicing the claimed invention, from the studies of the drawings, this disclosure and the claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE SIGNS

100 Notification system

110 Insulation panel

120 Read-out device

130 Computing device

140 Out-put device

1.-15. (canceled)

16. Insulation panel (110) comprising:
at least one sensor unit comprising at least one moisture senor configured to provide moisture data;
at least one communication interface configured to establish a communication with a read-out device and to transmit the moisture data to the read-out device;
at least one memory unit configured to store identification data of the insulation panel.

17. Insulation panel (110) according to claim 16, wherein the sensor unit, the memory unit and the communication interface are provided as an integrated part.

18. Insulation panel (110) according to claim 16, wherein the sensor unit further comprises at least one temperature sensor configured to provide temperature data.

19. Insulation panel (110) according to claim 16, wherein the sensor unit further comprises at least one pressure sensor configured to provide pressure data or at least one acoustic sensor configured to provide acoustic data.

20. Insulation panel (110) according to claim 16, wherein the sensor unit further comprises at least one radon sensor configured to provide radon exposure data.

21. Insulation panel (110) according to claim 16, wherein the memory unit is further configured to store data referring to the material of the insulation panel.

22. Insulation panel (110) according to claim 16, wherein the insulation material of the insulation panel is Styrodur, Neopor, Styropor, mineral wool, rock wool, silica aerogel, polyurethane aerogel, polyurethane foam, organic materials, like cellulose or straw, or a mixture of these insulation materials.

23. Insulation panel (110) according to claim 16, wherein the sensor unit, the communication interface or the memory unit are configured to collect energy transmitted by a read-out device.

24. Notification system (100) comprising:
at least one insulation panel (110) according to claim 16;
at least one read-out device (120) configured to establish a communication with the communication interface of the insulation panel (110) and receive at least the moisture data and the identification data of the insulation panel;
at least one analysis unit (130) to which at least the moisture data and the identification data of the insulation panel is transmitted and wherein the at least one analysis unit (130) is configured to provide notification massages based on the moisture data and the identification data of the insulation panel (110).

25. Notification system (100) according to claim 24, wherein the at least one read-out device (120) is a handheld device or an on-site device positioned within a transmission range of the communication interface of at least one insulation panel (110) such that a communication between the read-out device (120) and the communication interface of the at least one insulation panel (110) can be established and data can be transmitted.

26. Notification system (100) according to claim 24, wherein the read-out device (120) comprises a position determining unit, preferably a Global Positioning System (GPS), configured to assign to the moisture data and identification data of the insulation panel (110) positioning information data.

27. Notification system (100) according to claim 24, wherein the at least one read-out device (120) is further configured to receive temperature data, pressure data or radon exposure data, wherein this data is transmitted to the at least one analysis unit (130), wherein the analysis unit (130) is further configured to provide notification massages further based on the temperature data, pressure data or radon exposure data.

28. Notification system (100) according to claim 24, wherein the insulation panel (110) and the on-site device (130) are configured to send and receive moisture data and identification data of the insulation panel (110) in predetermined time intervals.

29. Notification system according to claim 24, wherein the at least one analysis unit (130) provides at least one of the following notification massages:
situation massage notifying a user about the read-out data assigned to at least one specific insulation panel (110);
inspection massage notifying a user that at least one specific insulation panel (110) has to be inspected;
alarm massage notifying a user that at least one specific insulation panel (110) has urgently to be replaced;
alarm massage notifying a user that at least one specific insulation panel (110) has a temperature above a predetermined value;
waste disposal massage notifying a user which waste treatment at least one specific insulation panel (110) requires.

30. Use of the moisture data, identification data, temperature data, pressure data or radon exposure data obtained from an insulation panel (110) according to claim 16 for determining at least one of the following notification massages:
situation massage notifying a user about the read-out data assigned to at least one specific insulation panel (110);
inspection massage notifying a user that at least one specific insulation panel (110) has to be inspected;
alarm massage notifying a user that at least one specific insulation panel (110) has urgently to be replaced;
alarm massage notifying a user that at least one specific insulation panel (110) has a temperature above a predetermined value;
waste disposal massage notifying a user which waste treatment at least one specific insulation panel (110) requires.

31. Insulation panel (110) according to claim 16, wherein the sensor unit, the memory unit and the communication interface are provided as an integrated part, wherein the integrated part is provided as a label, which is applied onto the insulation panel by means of an adhesive layer.
